(19) United States
(12) Patent Application Publication
(10) Pub. No.: US 2007/0054551 A1
(43) Pub. Date: Mar. 8, 2007

(54) Optical transceiver and cage system to prevent insertion of new transceiver models into legacy cages

(75) Inventors: Gerald Daniel Malagrino JR., Rochester, MN (US); Michael L. Zumbrunnen, Rochester, MN (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 11/411,076

(22) Filed: Apr. 25, 2006

Related U.S. Application Data
(60) Provisional application No. 60/715,102, filed on Sep. 8, 2005.

(51) Int. Cl. H01R 13/648

(52) U.S. Cl. 439/607

(57) ABSTRACT

To prevent newly developed transceiver modules from being plugged into legacy cages, which may not have the correct electrical connector therein, the new transceiver modules are built with one or more tabs extending outwardly therefrom for abutting an edge of the opening of the cage, thereby preventing the transceiver module from being fully inserted into the cage. New cages, which include the correct electrical connector, are built with slots extending from the opening of the cage to enable the tabs to pass freely, thereby enabling the transceiver module to be fully engaged in the new cage.

### CROSS-REFERENCE TO RELATED APPLICATIONS

The present invention claims priority from U.S. Patent Application No. 60/715,102 filed Sep. 8, 2005, which is incorporated herein by reference for all purposes.

### TECHNICAL FIELD

The present invention relates to an optical transceiver and cage system, and in particular to an optical transceiver and cage system that enables a new or a legacy transceiver module to be plugged into a new cage, but prevents a new transceiver model from being plugged into a legacy cage.

### BACKGROUND OF THE INVENTION

A conventional opto-electronic system, illustrated in FIG. 1, includes an opto-electronic module 1, e.g. a transceiver, and a cage/guide rail assembly 2. The module 1 includes an optical connector 3 at a front end thereof, and an electrical connector 4 at a rear end thereof. Typically, the optical connector 3 includes a pair of ports for receiving a first optical fiber to be optically coupled to a receiver optical sub-assembly (ROSA), and a second optical fiber to be optically coupled to a transmitter optical sub-assembly (TOSA). The TOSA and the ROSA are disposed adjacent one another on a module printed circuit board within a module housing 6. For convenience, the electrical connector 4 is formed on an edge of the module printed circuit board.

The cage/guide rail assembly is for mounting in a host computer device, and includes a faceplate 7 mounted on an edge of a host printed circuit board 8, and a cage or guide rail 9 mounted on the host circuit board 8 extending from the faceplate 7. An access hole 10 is provided in the faceplate 7 enabling the module 1 to pass therethrough into the cage 9. An electrical connector 11 is mounted within the cage 9 for receiving the electrical connector 4, and for transmitting electrical signals between the host computer device and the opto-electronic module 1.

Conventional optical transceiver cages are generally rectangular in shape with a rectangular opening in one end thereof for receiving the optical transceiver module. In the past, most major changes in transceiver design were accompanied by a change in the overall size of the module, i.e. from larger to smaller at one data rate (1 or 2 Gb/s), and then from larger to smaller again at larger data rates (10 Gb/s). Accordingly, there was very little confusion over which transceivers were for which cages, since only the correct transceiver would fit in the correct cage. However, recent developments in transceiver technology have not effected the size of the module resulting in some confusion over whether certain cages are compatible with certain transceiver modules, i.e. whether the cage includes certain advanced features that legacy cages do not have in their electrical interfaces.

An object of the present invention is to overcome the shortcomings of the prior art by providing an optical transceiver system in which new transceiver modules can not be plugged into legacy transceiver cages, while both new and legacy transceiver modules can be plugged into new transceiver cages.

### SUMMARY OF THE INVENTION

Accordingly, the present invention relates to a transceiver system for mounting on a host device comprising:

an opto-electronic transceiver module including: a housing including at least one tab extending therefrom; an optical coupler on a front end of the housing for coupling at least one optical fiber; at least one optical sub-assembly (OSA) for converting optical signals to electrical signals or vice versa; a printed circuit board for controlling each OSA, and transmitting electrical signals between the OSA and the host device; and a first electrical connector electrically connected to the printed circuit board; and

a transceiver cage including an open front end for receiving the transceiver module, a second electrical connector for mating with the first electrical connector when the transceiver is fully inserted into the cage, and a slot for receiving each tab;

whereby each tab on the transceiver module will become fully engaged into each slot on the cage to enable the first and second electrical connectors to be connected, while the tabs on the transceiver module prevent the transceiver module from being fully inserted into a legacy cage without matching slots therein.

Another aspect of the present invention relates to a transceiver module for mounting in a cage on a host printed circuit board comprising:

a housing including at least one tab extending therefrom;

an optical coupler on a front end of the housing for coupling at least one optical fiber;

at least one optical sub-assembly (OSA) for converting optical signals to electrical signals or vice versa;

a printed circuit board for controlling each OSA, and transmitting electrical signals between the OSA and the host device; and

an electrical connector electrically connected to the printed circuit board;

whereby the tab prevents the transceiver module from being fully plugged into a cage without matching slots therein.

Another aspect of the present invention relates to a transceiver cage for mounting on a host printed circuit board for receiving a transceiver module therein comprising:

an open front end for receiving the transceiver module;

an electrical connector for mating with an electrical connector on the transceiver module when the transceiver module is fully inserted into the cage; and

a slot for receiving each tab, thereby enabling a transceiver module with one or more tabs extending therefrom to become fully inserted therein.

### BRIEF DESCRIPTION OF THE DRAWINGS

The invention will be described in greater detail with reference to the accompanying drawings which represent preferred embodiments thereof, wherein:

FIG. 1 is an isometric view of a conventional optical transceiver system;

FIG. 2 is an isometric view of a optical transceiver system according to an embodiment of the present invention;

FIG. 3 is an isometric view of an optical transceiver system according to an embodiment of the present invention;

FIG. 4 is an isometric view of a optical transceiver system according to an embodiment of the present invention;

FIG. 5 is an isometric view of an optical transceiver system according to an embodiment of the present invention;

FIG. 6 is an isometric view of a optical transceiver system according to an embodiment of the present invention;

FIG. 7 is a top view of the optical transceiver module of FIG. 6; and

FIG. 8 is an isometric view of an optical transceiver cage according to an embodiment of the present invention.

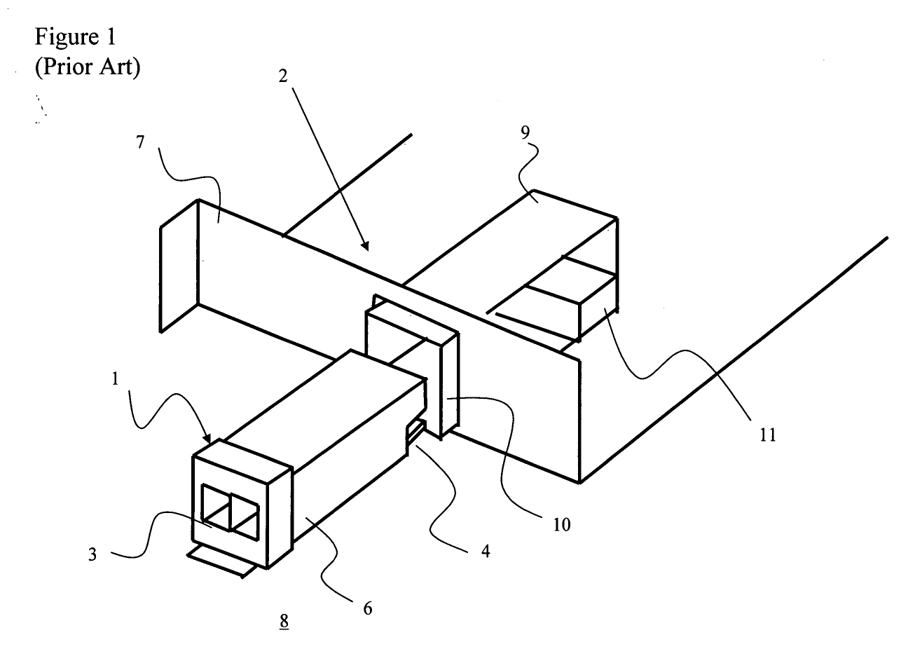

### DETAILED DESCRIPTION

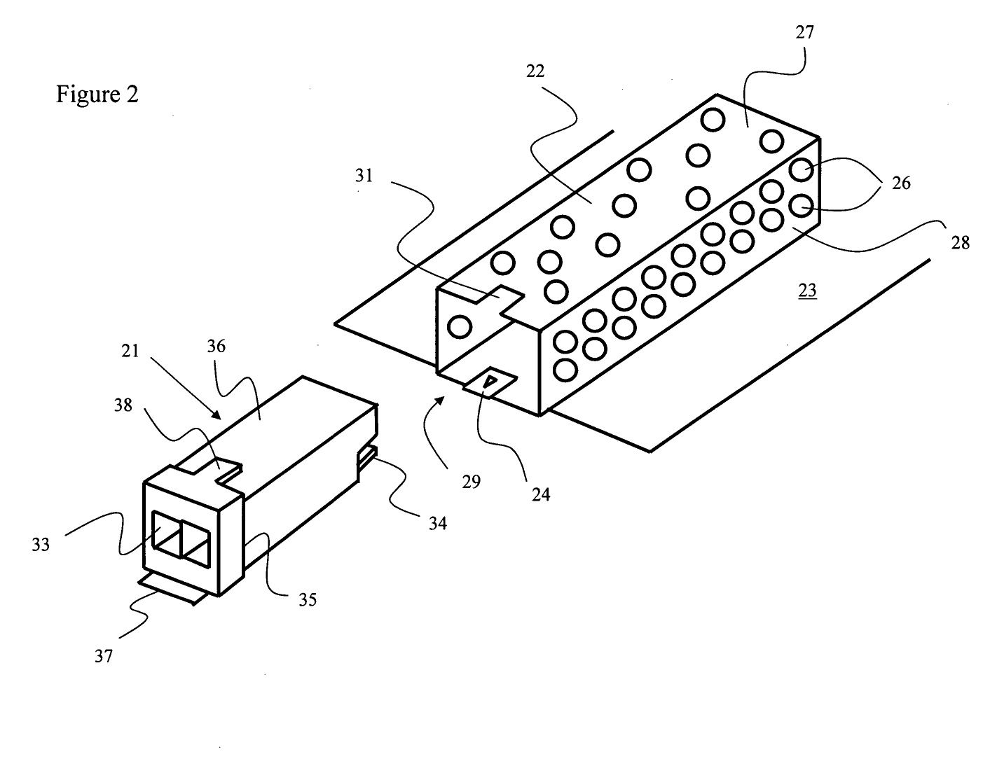

With reference to FIG. 2, an optical transceiver system, according to an embodiment of the present invention, includes a generally rectangular optical transceiver module 21 and a rectangular optical transceiver cage 22. The cage 22 has dimensions suitable to accept the transceiver module 21 in accordance with multi-source agreement standards, and is mounted on a host printed circuit board 23 with a host electrical connector therein. Some form of latching feature is usually provided on the cage, such as flexible tongue 24 for engaging a latch on the transceiver module 21. Perforations 26 are provided in the upper wall 27 and the side wall 28 of the cage 22 to enable air to circulate over the transceiver module 21 for dissipating heat therefrom. The cage 22 has a rectangular open front end 29 enabling the transceiver module 21 to be slideably received therein. A slot or cut-out 31 in the upper wall 27 extends from the front edge thereof, i.e. the open front 29, towards the rear end of the cage 22.

The transceiver module 21 includes an optical connector 33 at a front end thereof, and an electrical connector 34 at a rear end thereof. The optical connector 33 comprises a duplex optical connector having a pair of ports, one for receiving a first optical fiber to be optically coupled to a receiver optical sub-assembly (ROSA), and a second port for receiving a second optical fiber to be optically coupled to a transmitter optical sub-assembly (TOSA). The TOSA and the ROSA are disposed adjacent one another on a module printed circuit board within a module housing 36. A shoulder 35 is formed in the front end of the module 21 for abutting the front edges of the top wall 27 and the side walls 28 of the cage 22 around the opening 29. For convenience, the electrical connector 34 is formed on an edge of the module printed circuit board. A bail latch 37 extends outwardly from the module housing 36 for grasping during insertion and retraction of the module 21, and for unlatching the tongue 24 from a mating latching feature extending from or pivotally mounted on the housing 36. A tab or key feature 38 extends from an upper surface of the module housing 36, preferably from the shoulder 35, for engaging the upper wall of legacy cages that do not have slots 31, thereby preventing the module 21 from becoming fully engaged therein. In a newer cage, such as the cage 22, which has the slot 31, the tab 38 is received in the slot 31, and thereby able to be fully engaged into the cage 22 with the electrical connector 34 plugged into the host electrical connector within the cage 22.

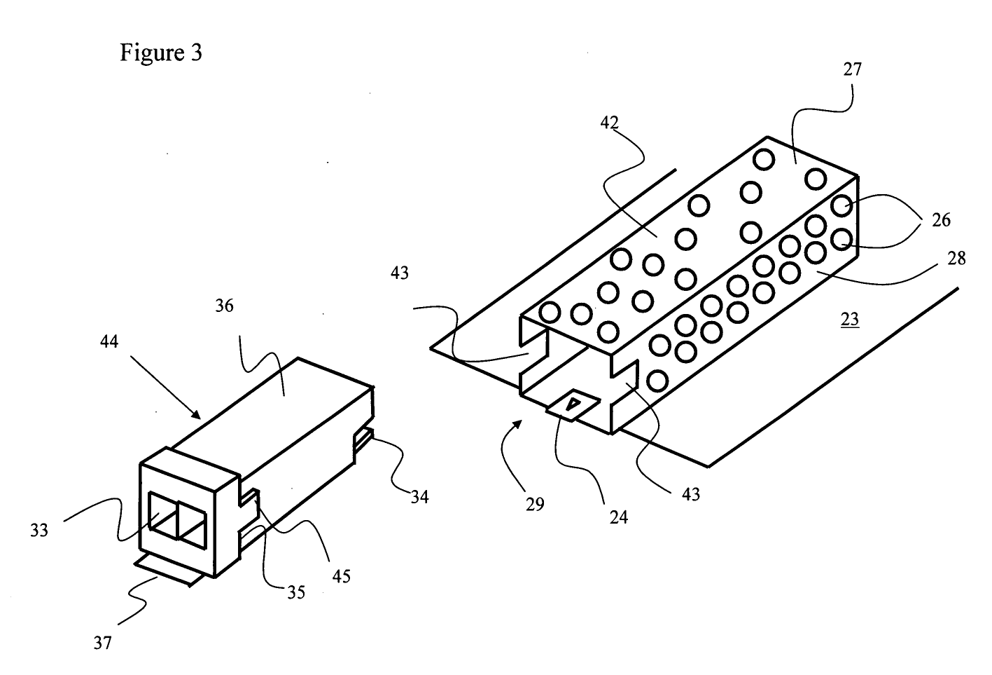

In an alternative embodiment of the present invention illustrated in FIG. 3, a cage 42 includes a pair of slots 43, one in each side wall 28 extending rearwardly from the front edges thereof, i.e. the open front end 29. Similar to the cage 22, the cage 42 is mounted on a host printed circuit board 23, and includes a tongue 24 and perforations 26 in the top wall 27 and the sidewalls 28. A corresponding transceiver module 44 includes a tab 45 extending from each side of the module housing 36, preferably from the shoulder 35. As above, the transceiver module 44 includes the optical connector 33, the electrical connector 34, and the bail latch 37.

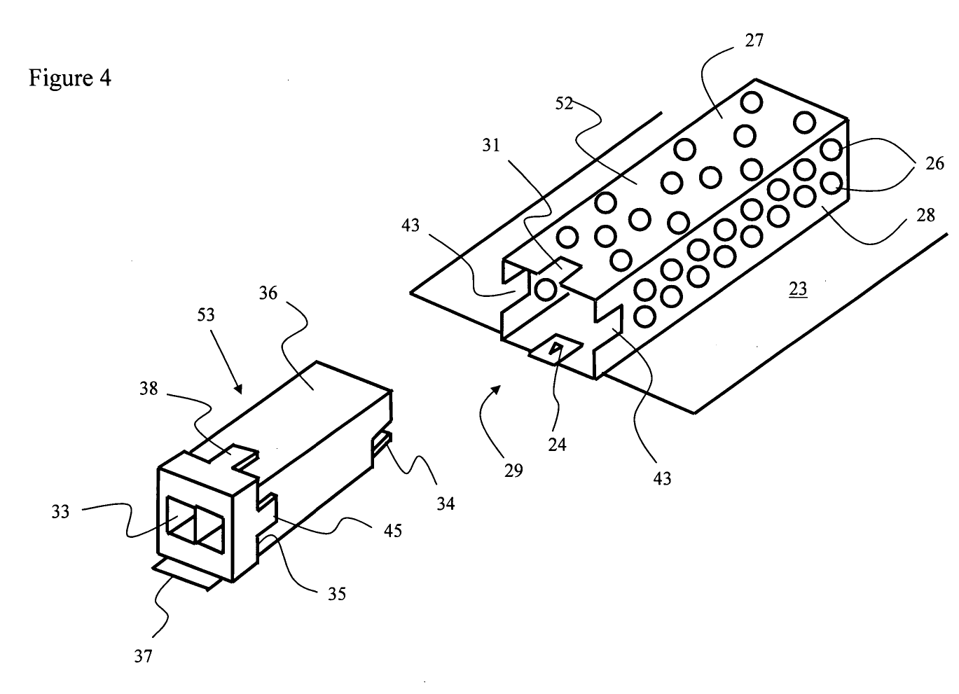

FIG. 4 illustrates another embodiment of the present invention, which combines the features of the previous two embodiments. Accordingly, a cage 52 includes the slot 31 in the upper wall 27 thereof, as well as the slots 43 in each of the sidewalls 28. Similar to the cage 22, the cage 52 is mounted on a host printed circuit board 23, and includes a tongue 24 and perforations 26 in the top wall 27 and the sidewalls 28. A transceiver module 53 includes the tab 38 extending from the upper surface thereof, and the tabs 45 extending from each side thereof. As above, the transceiver module 53 includes the optical connector 33, the electrical connector 34, and the bail latch 37.

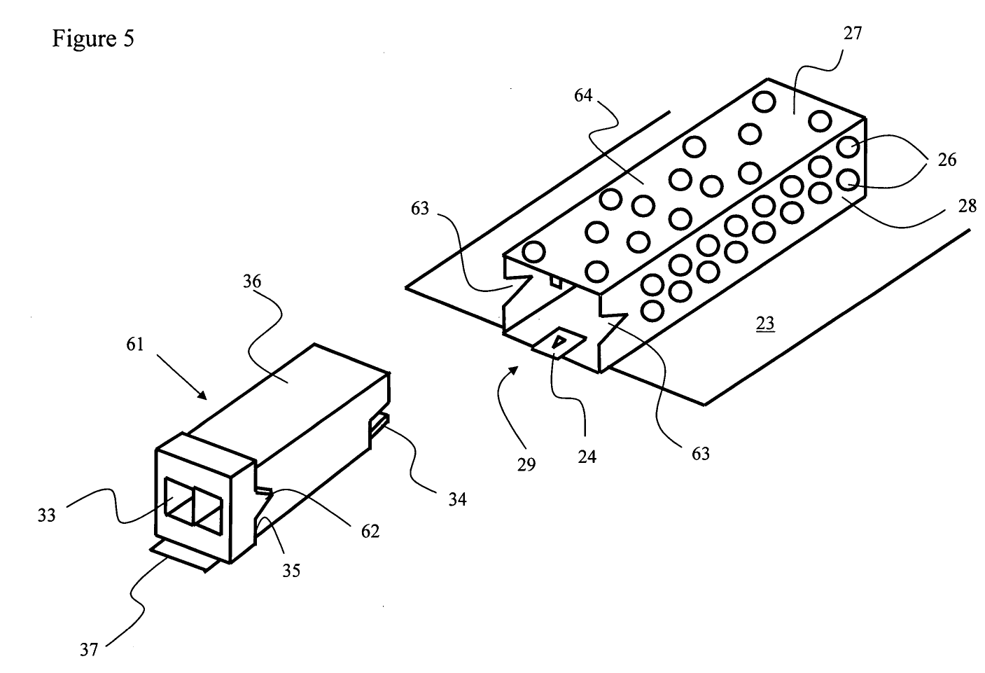

With reference to FIG. 5, a transceiver module 61, similar to the aforementioned transceiver modules 21, 43 and 53, includes tabs 62 which have tapered leading ends for facilitating the insertion of the module 61 into slots 63 on a corresponding cage 64. The tapered leading edge provides a greater clearance during initial insertion of the tabs 62 into the slots 63, and acts to guide the transceiver module 61 into position. In the illustrated embodiment, the tabs 62 are triangular in shape with a pointed leading edge, but other shapes, e.g. spherical, pentagon, octagon, are possible within the scope of the invention. The corresponding cage 64 can include rectangular slots 43, as in the previous embodiments, or matching triangular slots 63, as illustrated.

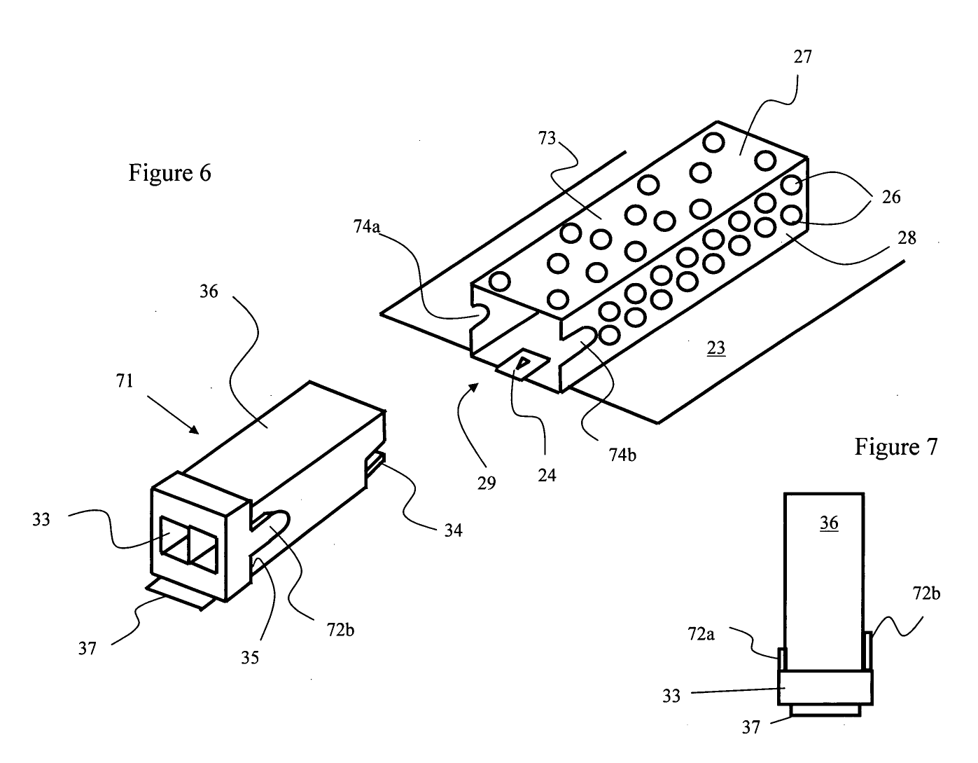

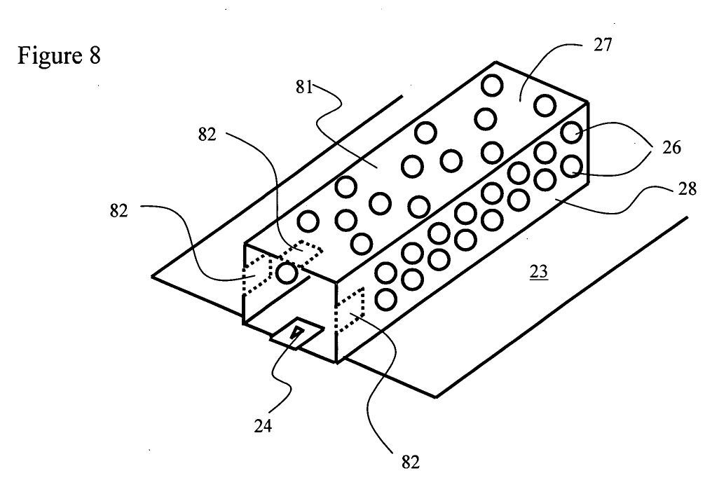

A transceiver module 71, illustrated in FIGS. 6 and 7, includes tabs 72a and 72b on each side of the housing 36 with rounded leading edges. The rounded leading edges are tapered, thereby providing the aforementioned advantages, plus they reduce the number of sharp edges provided with square or rectangular tabs and slots. In this embodiment, the tab 72a is longer and extends farther down the side of the housing 36 than tab 72b. In the corresponding cage 73 slot 74a is sized to receive tab 72a, while slot 74b is sized to receive tab 74b. Accordingly, the tab 72a will abut the end of slot 74b before the module 71 is able to be fully plugged into the cage 73, thereby providing a stop in case an attempt is made to insert the module 71 upside down into the cage 73.

To minimize inventory and the number of different cages required for the various systems, a cage 81, according to another aspect of the present invention, is constructed with frangible or perforated flaps 82, which can be removed by the end user in accordance with which particular transceiver module is being used, e.g. a transceiver module with upper surface tabs 38, side wall tabs 44 or both. Each flap 82 can also be of any shape or size, and include a plurality of sections depending on the shapes and sizes of the tabs being used.

We claim:

1. A transceiver system for mounting on a host device comprising:
an opto-electronic transceiver module including:
a housing including at least one tab extending therefrom;
an optical coupler on a front end of the housing for coupling at least one optical fiber;
at least one optical sub-assembly (OSA) for converting optical signals to electrical signals or vice versa;
a printed circuit board for controlling each OSA, and transmitting electrical signals between the OSA and the host device; and
a first electrical connector electrically connected to the printed circuit board; and
a transceiver cage including an open front end for receiving the transceiver module, a second electrical connector for mating with the first electrical connector when the transceiver is fully inserted into the cage, and a slot for receiving each tab;
whereby each tab on the transceiver module will become fully engaged into each slot on the cage to enable the first and second electrical connectors to be connected, while the tabs on the transceiver module prevent the transceiver module from being fully inserted into a legacy cage without matching slots therein.

2. The system according to claim 1, wherein each slot extends from the open front end along a side or top of the cage.

3. The system according to claim 1, wherein each tab extends from a side of the module proximate the front end thereof.

4. The system according to claim 1, wherein each tab includes a tapered leading edge to facilitate insertion into each slot.

5. The system according to claim 1, wherein each tab and each slot comprise a shape selected from the group consisting of rectangular, triangular, spherical, pentagonal, and octagonal.

6. The system according to claim 1, wherein the at least one tab comprises first and second tabs, one extending from each side of the module; and wherein each cage includes first and second slots, one on either side thereof.

7. The system according to claim 6, wherein the first tab is longer than the second tab; and wherein the first slot is shorter than the second tab, whereby the second tab will abut an end of the first slot preventing the transceiver module from being fully inserted into the cage when the transceiver module is inserted upside down.

8. The system according to claim 1, wherein at least one of the slots is populated by a flap with perforated edges, removable prior to insertion of the transceiver module.

9. A transceiver module for mounting in a cage on a host printed circuit board, the cage including at least one slot extending therein, comprising:
a housing including at least one tab extending therefrom;
an optical coupler on a front end of the housing for coupling at least one optical fiber;
at least one optical sub-assembly (OSA) for converting optical signals to electrical signals or vice versa;
a printed circuit board for controlling each OSA, and transmitting electrical signals between the OSA and the host device; and
an electrical connector electrically connected to the printed circuit board;
whereby each tab prevents the transceiver module from being fully plugged into a cage without matching slots therein.

10. The transceiver module according to claim 9, wherein each tab extends from a side of the housing proximate the front end thereof.

11. The transceiver module according to claim 9, wherein each tab includes a tapered leading edge to facilitate insertion into each slot.

12. The transceiver module according to claim 9, wherein each tab comprises a shape selected from the group consisting of rectangular, triangular, spherical, pentagonal, and octagonal.

13. The transceiver module according to claim 9, wherein the at least one tab comprises first and second tabs extending from opposite sides of the module; and wherein each cage includes first and second slots on opposite sides thereof.

14. The transceiver module according to claim 13, wherein the first tab is longer than the second tab; and wherein the first slot is shorter than the second tab, whereby the second tab will abut an end of the first slot preventing the transceiver module from being fully inserted into the cage when the transceiver module is inserted upside down.

15. A transceiver cage for mounting on a host printed circuit board for receiving a transceiver module having at least one tab extending therefrom comprising:
an open front end for receiving the transceiver module;
an electrical connector for mating with an electrical connector on the transceiver module when the transceiver module is fully inserted into the cage; and
a slot for receiving each tab, thereby enabling a transceiver module with the at least one tab to become fully inserted therein.

16. The transceiver cage according to claim 15, wherein each slot extends from the open front end along a side or top of the cage.

17. The transceiver cage according to claim 15, wherein at least one of the slots is populated by a flap with perforated edges, removable prior to insertion of the transceiver module.

18. The transceiver cage according to claim 15, wherein each slot comprises a shape selected from the group consisting of rectangular, triangular, spherical, pentagonal, and octagonal.

19. The transceiver cage according to claim 15, wherein the at least one slot comprises first and second slots, one extending along opposite sides of the cage.

20. The transceiver cage according to claim 19, wherein the first slot is longer than the second slot, thereby preventing a transceiver module from being fully inserted into the cage when the transceiver module is inserted upside down.
